(19) United States
(12) Patent Application Publication
(10) Pub. No.: US 2003/0014133 A1
(43) Pub. Date: Jan. 16, 2003

(54) Algorithm and software computing minkowski quotients, products, and sums of polygons, and for generating feasible regions for robust compensators

(76) Inventors: Laurence Edward LaForge, Reno, NV (US); M. Sami Fadali, Reno, NV (US)

Correspondence Address: NATH & ASSOCIATES PLLC, 6th Flooor, 1030 15TH Street NW, Washington, DC, 20005, US

(21) Appl. No.: 10/060,278

(22) Filed: Feb. 1, 2002

Related U.S. Application Data
(60) Provisional application No. 60/265,679, filed on Feb. 2, 2001.

(51) Int. Cl. G06F 17/00

(52) U.S. Cl. 700/90; 700/52

(57) ABSTRACT

The invention is a method, or a computer implementation thereof, which computes the boundaries of sets that result when two or more sets are multiplied or divided, in the vector sense attributed to Minkowski. In a preferred form, the invention is a novel and useful enabler for devising compensators that effect robust control. Control system designers desire compensators that are robust to uncertainties in plant parameters. The invention solves this problem by identifying, for any frequency, those points in the complex plane which can be mapped into compensators. When applied to the design of control systems, the invention pertains either in the case of a single frequency, or to multiple frequencies. It also pertains to either single or multiple inputs or outputs. The invention generalizes to multi-dimensional applications, not necessarily control-theoretic, wherein problems can be modeled by combinations of Minkowski quotients, products, and sums.

### BACKGROUND OF THE INVENTION

Designers seek robust compensators that place the nominal system response within specified bounds. The resulting system performance is therefore tuned to a nominal, prescribed set of parameters governing a system, or plant as it is known in control theory. In practice, the best estimates for plant parameters are often bounded intervals. In a particular launch control system, for example, vehicle inertia is bracketed in the range [1400, 11000] kg-meter², the axle shaft spring constant is in the range [58000, 115000] (Newton-meter)/radian, and change in clutch torque per unit change in clutch position is bounded between 100 and 800 (Newton-meter)/millimeter. Similar uncertainties arise in designing control systems for jet aircraft, such as the F4-E Phantom. Designers therefore desire compensators that are robust to uncertainties in plant parameters. The invention solves this problem by identifying, for any frequency, those points in the complex plane which can be mapped into compensators. For example, in the complex s (i.e., Laplace transform) domain, the invention solves for the set C={C(jω))} satisfying:

$${M}_{shape}^{-} {\leq }^{a} \frac{1}{\vert [ {P}^{- 1 •} ( jω ) = {B}^{•} ( jω ) / {A}^{•} ( jω ) ] + C ( jω ) \vert} {\leq }^{b} {M}_{p e a k}^{+}$$

Here P⁻¹ is the reciprocal of the system closed-loop transfer function, expressed as the ratio of two polynomials A and B. The boxed superscripts indicate that the polynomials range over a polygonal range of uncertainty. For the particular case of interval uncertainty the polygons reduce to Kharitonov rectangles whose sides parallel the real and imaginary axes. M⁻_{Shape} and M⁺ₚₑₐₖ are constraints on shape resp. peak actuator amplitude. As is customary in frequency response analysis, we have replaced s with jω; j is the square root of minus one, and ω is a fixed but arbitrary angular frequency. The set C is the feasible region of compensation, and is illustrated in FIG. 2. C is of primary interest to the designer, and is computed by the invention. Refer to FIG. 1. In the process, the invention explicates the boundary of the (not necessarily rectangular) Minkowski quotient −P^{-1□}=−B^{□}/A^{□}; equivalently, of P^{□}=A^{□}/B^{□}.

As a simple but concrete scenario, consider the region determined by the peak bound alone. The invention solves the following:

Inputs: frequency ω₀; m+n+2 intervals determining A^{□}(jω₀) and B^{□}(jω₀); bound M⁺ₚₑₐₖ

Output: C⁺ₚₑₐₖ

A complementary solution in the case of, say, shaping bounds yields a different region, which, if compensation is feasible, overlaps the region determined by the peak bounds. In addition to computing these regions separately, the invention outputs their intersection; i.e., the feasible region of compensation C.

More generally, and in the domain of robust control, the invention computes and explicates feasible regions of compensation. Prior art for robust control proceeded without cognizance of the compensator plane, a novel aspect of the present invention. Even more generally, the invention computes the boundaries of sets obtained by combinations of Minkowski set quotients and set products. Such sets include, but are not limited to, those with polygonal or polyhedral boundaries. Such quotients and products include, but are not limited to, cases where the regions are subjected to constraints, such as the peak and shaping bounds mentioned above. [Fadali and LaForge 2001] elaborate the invention's background in greater detail.

### BRIEF SUMMARY OF THE INVENTION

The invention is an algorithmic method (which may subsume several sub-methods), or, in a preferred embodiment, a computer program that incorporates the algorithmic method, perhaps, but not necessarily, with a graphical user interface (GUI).

Based on user input, a preferred embodiment of the invention generates a representation of a region in the complex plane or space that corresponds to the reciprocal, or negative reciprocal, of a plant transfer function, as it is known in the theory of control systems (FIG. 1: −P^{-1□}). Such a region is a set of complex numbers that span the range of values obtained by dividing the region of uncertainty of a plant transfer function numerator (typically a polygon), by the region of uncertainty of the plant transfer function denominator (also a polygon in the typical case). Such regions include, but are not limited to, rectangular Kharitonov value sets, parallel to the real and imaginary axes, and obtained by evaluating the respective Kharitonov polynomials whose coefficients are bounded by intervals of uncertainty (FIG. 1: A^{□}, −B^{□}). The invention explicates the boundary of this quotient region. None of the regions, input or output, need necessarily be connected.

### BRIEF DESCRIPTION OF THE DRAWINGS

FIG. 1 illustrates the Minkowski quotient where

$${P}^{•} ( s ) = \frac{{A}^{•} ( s )}{{B}^{•} ( s )} = \frac{[ 1 , 2 ] s + [ 1 , 2 ]}{[ 1 , 2 ] {s}^{2} + [ 1 , 2 ] s + [ 1 , 2 ]}$$

FIG. 2 shows the entire solution for the feasible region C, after computing the Minkowski sum, and after performing a breadth first search on the winding numbers on the arcs in the attendant convolution graph. FIG. 2 illustrates C in the case of strong A/B dependence: some, but not all, of the numerator terms are identical to those in the denominator.

### DETAILED DESCRIPTION OF THE INVENTION

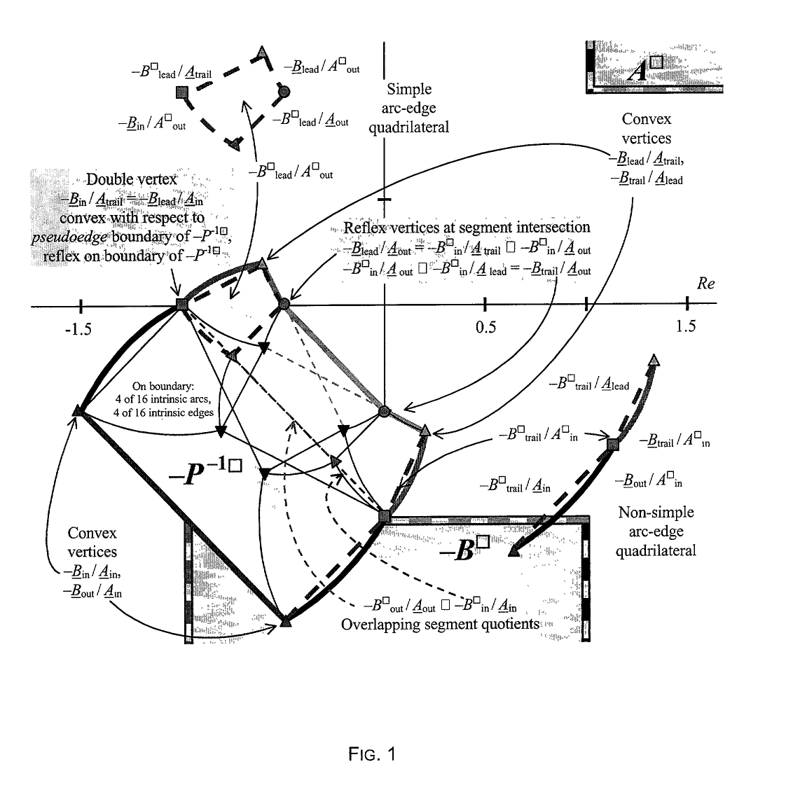

When manifested as a computer program, the invention may pictorially plot the quotient region boundary (FIG. 1: −P^{-1□}). Such a pictorial representation is not essential, however, and the invention may alternatively represent the quotient region boundary in coordinate or parametric forms, or otherwise as is customary in the domain of scientific computing. More generally, the invention computes the Minkowski quotient or Minkowski product of arbitrary shapes, and explicates the boundary of the resulting (not necessarily connected) region.

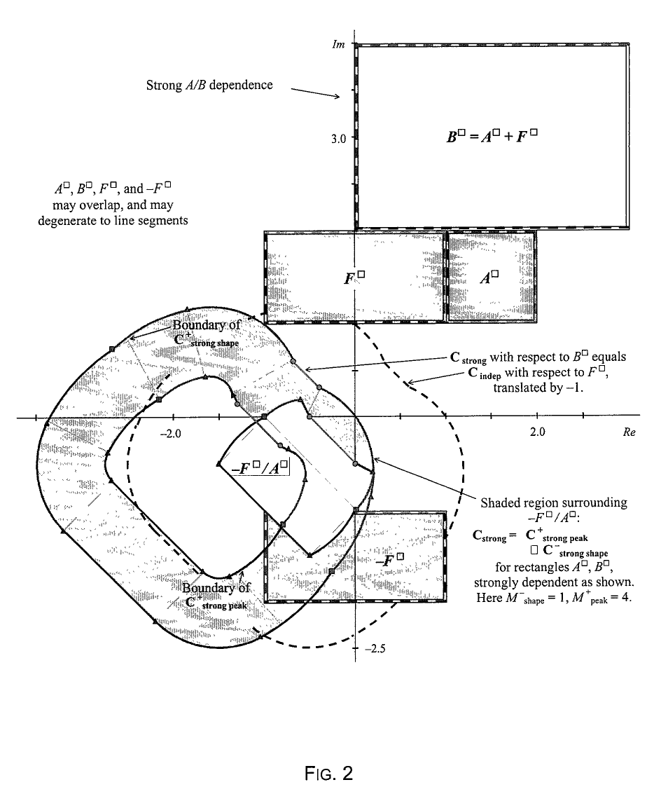

The invention may also compute the set of points at a prescribed distance from the region determined by the Minkowski quotient or product of two or more shapes (FIG. 2). This distance operation is a special case of the Minkowski sum. In the design of control systems, the distance set reflects system constraints on the plant transfer function. Such constraints include, but are not limited to, lower bounds on the plant transfer function magnitude imposed by shaping criteria for the system response. Peak gain is an example of an upper bound on plant transfer function magnitude. Other constraints include tracking bounds, sensitivity bounds, and actuator limitations. Though the preceding list is not exhaustive, the constraints share a common characteristic: they govern the boundary of the complex feasible region whereby a compensator, if fit within the region, places the system response within specification. A substantive portion of the novelty of the invention is realized by its ability to efficiently and accurately explicate this resulting region. The distance determined by a constraint need not be constant, but may vary, for example, as a function of location within the Minkowski quotient or product.

When applied to the design of control systems, the invention pertains either in the case of a single frequency, or to multiple frequencies. It also pertains to either single or multiple inputs or outputs.

When applied in the more general context of computational geometry or applications thereof, the invention may include an operation that performs a Minkowski sum with the region corresponding to the Minkowski quotient or product (FIG. 2). As with the computation of Minkowski quotient or product alone, the invention extracts the boundary of the region, after the Minkowski addition is carried out. A substantive portion of the novelty of the invention is realized by its ability to enumerate and sort the winding numbers of the Minkowski convolution graph, and to find cycles in this graph whose winding number equals zero [Fadali and LaForge 2001]. The set which is added to the Minkowski quotient may be any set in the plane that can be definitively expressed in a finite number of symbols. Such sets include, but are not limited to, disks of fixed radius, centered at the origin.

The invention also applies to Minkowski quotients, products, and sums in dimensions greater than two, and in any metric space. The latter include, but are not limited to, the Lₚ metric spaces. The latter include, but are not restricted to, spaces over the L₁ (Minkowski), L₂ (Euclidean), and L_{∞} metrics.

The invention may also perform geometric translates, rotates, morphs, or other transformations of the Minkowski sets. Such operations may be carried out on intermediate results, or on the result of any combination of Minkowski quotient, product, or sum. FIG. 2 illustrates an example: to compute a feasible region of compensation, where the plant numerator and denominator depend strongly upon one another, the invention may obtain a feasible region by translating another feasible region.

Although the beneficial behavior of the invention has been described primarily with respect to control systems, it should be apparent that an analogous behavior is possible in the more general case, for any problem modeled using Minkowski quotients, or Minkowski quotients and sums. Further, since vector division is equivalent to vector multiplication, the invention pertains to problems whose solution involves Minkowski products, products and quotients, or combinations of Minkowski products, quotients, and sums.

It is understood that the invention is capable of further modification, uses and/or adaptations following in general the principle of the invention and including such departures from the present disclosure as come within known or customary practice in the art to which the invention pertains, and as may be applied to the essential features set forth, and fall within the scope of the invention, with specific claims enumerated henceforth.

We claim:

1. A method for computing Minkowski set quotients, products, and sums, comprising
inputting a representation of the sets on which the operations are to be performed;
outputting a representation of the results of the operations

2. The method as recited in claim 1, with quantitative constraints on the results of the operation.

3. The method as recited in claim 1, in combination with Minkowski set addition or subtraction.

4. The method as recited in claim 1, where winding numbers are used to distinguish set boundaries.

5. The method as recited in claim 1, where the input sets are polygonal or polyhedral.

6. The method as recited in claim 1, when applied to problems of robust control.

7. The method as recited in claim 1, when applied to problems of robust control, such that the input sets are determined by Kharitonov polynomials of a transfer function.

8. A system, including, but not limited to, a computer system, with means for automating the method of claim 1.

9. A system, including, but not limited to, a computer system, with means for automating the method of claim 2.

10. A system, including, but not limited to a computer system, with means for automating the method of claim 3.

11. A system, including, but not limited to, a computer system, with means for automating the method of claim 4.

12. A system, including, but not limited to, a computer system, with means for automating the method of claim 5.

13. A system, including, but not limited to, a computer system, with means for automating the method of claim 6.

14. A system, including, but not limited to, a computer system, with means for automating the method of claim 7.
